(19) United States
(12) Patent Application Publication
(10) Pub. No.: US 2008/0027823 A1
(43) Pub. Date: Jan. 31, 2008

(54) SYSTEM AND METHOD FOR PURCHASING ITEMS ON THE INTERNET USING A COMPUTER TERMINAL WITH A PLIANT CURRENCY ACCEPTOR

(76) Inventor: MATTHEW PETRUCCELLI, Hollywood, FL (US)

Correspondence Address: ROBERT M. SCHWARTZ, P.A., P.O. BOX 221470, HOLLYWOOD, FL, 33022, US

(21) Appl. No.: 11/828,837

(22) Filed: Jul. 26, 2007

Related U.S. Application Data
(60) Provisional application No. 60/833,590, filed on Jul. 27, 2006.

(51) Int. Cl. G06Q 30/00; G07F 17/40

(52) U.S. Cl. 705/26

(57) ABSTRACT

A system and method is provided for providing a public online computer terminal providing the general public a manner of purchasing goods or services using a pliant currency acceptor that records the value of currency inserted and transmits information as to this value to a desired Internet vendor.

### INDEX TO RELATED APPLICATIONS

This application claims the benefit of U.S. Provisional Patent Application Ser. No. 60/833,590, filed Jul. 27, 2007, which is incorporated herein by reference in its entirety.

### BACKGROUND OF THE INVENTION

Several attempts have been made in recent years to bring computing equipment into the public arena. The problem of purchasing merchandise and services for public online global telecommunications network has yet to be solved. Finally, some have used the method of attaching a credit card swipe machine, such as those found on gas pumps. Unfortunately, this assumes that the user has a credit card and is willing to trust it to an open machine. Still others use an electrical coin operated accumulator, such as shown in U.S. Pat. No. 5,240,098 to Desai, to enable use of a personal computer in a public venue. Coin operated accumulators are limited, however in the amount of money that can be easily inserted to pay for purchase merchandise and services online. While pliant currency acceptors are known for use with standard vending machines they are not readily adaptable for use with a digital computer terminal such as required for global telecommunications access to purchase merchandise and services.

Online global telecommunications network access to purchase merchandise and services. There are many disadvantaged populations in the United States for instance, that do not have access to online global telecommunications services. Generally this is due to the high cost of digital computer equipment and the complexities of configuring the machine.

There is a need for providing a computer integrated with a pliant currency detector that would allow a person to make a cash purchase over the Internet.

A pliant currency detector or sometimes referred to as a currency detector is a device that determines if a piece of currency is, or is not, counterfeit. These devices are used in vending machines that accept payment and dispense a product to a customer. They are also used in change machines and in slot machines.

The basic process involves looking at the currency that has been inserted and by using various tests, determine if the currency is counterfeit. Since the parameters are different for each coin or paper money, these detectors must be programmed for each item that they need to accept. In operation, if the item is accepted it is retained by the machine and placed in a storage device. If the item is rejected, the machine returns the item. If it is a coin, it usually drops into a container for the customer to take back. If it is a bill, the machine pushes the bill out and the customer must remove it from the slot in which it was placed.

Also known as bill validators or bill acceptors, paper currency detectors scan pliant currency using optical and magnetic sensors. Upon validation, the bill validator will inform the vending machine controller (VMC) or other host device of a credit via a parallel or serial interface. Various interfaces exist for the host device including a single-line pulse interface, a multi-line parallel interface, a multi-line binary interface, and serial interfaces such as ccTalk, SSP, MDB2PC and MDB2USB. Wrinkled or creased bills can cause these machines to reject the bills.

There are currently only a handful of companies in the world manufacturing this type of equipment. MEI (West Chester, Pa.) and Japan Cash Machine (Osaka, Japan) are two of the largest, each maintaining dominance in a particular market segment.

### BRIEF SUMMARY OF THE INVENTION

The present invention provides an online global telecommunications network to purchase merchandise and services via a digital computer connected to a pliant currency acceptor both housed in a sturdy, tamper-resistant housing that can be effectively installed in public venues for direct public use. Suitable circuits and software are provided to convert the pliant currency acceptor output into a digital computer input that can be recognized at one of its serial ports which enables the user to purchase merchandise and services

It is therefore an object of the present invention to provide a public online computer terminal with a pliant currency acceptor together with suitable software and circuitry to permit access to a user online global telecommunications network to purchase merchandise and services for the amount of money inserted in the pliant currency acceptor.

It is another object of the present invention to provide a public online computer terminal with a pliant currency acceptor that is self-operating and does not require an attendant to offer the service.

It is another object of the present invention to provide a public online computer terminal with a pliant currency acceptor that is simple in design and construction, reliable in use, and economical to manufacture.

These and other and further objects of the present invention will become apparent from time to time throughout the specification and claims herein.

### DETAILED DESCRIPTION OF THE PREFERRED EMBODIMENTS

The present invention provides for cash transactions over the internet. It is contemplated that the cash transactions may be an internet purchase for goods or services. Alternatively, it is further contemplated that the present invention may be used for delivering cash to a person whereby that person may receive cash in one of many ways.

The originator (the person sending the cash) would deposit cash in the pliant currency acceptor, and may direct cash to an individual's bank account, or there may be a remote location whereby the person receiving the cash can go and retrieve cash based on money deposited by the depositor. The owner of the online computer terminal may charge a surface charge to the purchaser. Alternatively, the owner of the online computer terminal of the subject invention may have an arrangement with particular companies or vendors whereby the owner would receive a percentages of purchases made through the system and method of the present invention. In one embodiment, the purchaser selects a purchase and has a choice of delivery options as is commonly known.

Alternatively, the system and method of the present invention may be utilized to prepay for an item, which the purchaser will then personally travel to a location and receive the goods purchased.

Another feature of the present invention would be appropriate software linked to the currency acceptor by which a purchaser may insert currency from a country other than the United States. The online terminal would query a currency exchange rate and credit the purchaser in U.S. dollars.

Because the system and method of the present invention is contemplated as an instrumentality of commerce, the internet access of the public online computer terminal of the present invention would be limited to shopping website.

The subject application provides for a method for purchasing items on the Internet comprising:
1. A method for purchasing items on the Internet comprising:
   (a) accessing a public online computer terminal said computer terminal comprising:
      (i) a digital computer having at least a memory, a CPU, a display, and input components;
      (ii) a pliant currency acceptor having output to said digital computer indicative of the amount of currency inserted therein;
      (iii) a serial interface circuit connected between said digital computer and said pliant currency acceptor;
      (iv) a public telecommunications interface connected to said digital computer and connected to a public telecommunications channel;
      (v) a software system on a computer readable medium, the system for the purchase of merchandise or services through the use of said terminal, wherein said software system includes a telecommunications software for purchasing merchandise and services through a global telecommunications network interface and a public telecommunications channel through the use of payments deposited into said pliant currency acceptor, wherein said pliant currency acceptor is used with said software system for determining the quantitative monetary value of currency inserted therein;
   (b) selecting an Internet purchase on said online computer terminal;
   (c) depositing currency into said pliant currency acceptor;
   (c) completing the purchase after a required amount of currency has been inserted into said pliant currency acceptor by transmitting to an Internet vendor a desired manner in which the purchaser will receive the goods or services purchased.

The method further comprises a circuit linking said pliant currency acceptor to said digital computer terminal that includes an optically isolated control operated by said digital computer.

In one embodiment, the method comprises a software package that records the value of currency inserted into said pliant currency acceptor and communicates the value inserted to an Internet vendor.

The method provides said software that includes a program for displaying on said digital computer display the services available on said global network; monitors the user's selections of desired services; and executes a subroutine program to provide the user the services selected.

In a preferred embodiment said software further includes a means for monitoring said pliant currency acceptor to determine the value of currency inserted and the additional value required to complete a purchase.

In the method, said serial interface circuits convert the output signal from the pliant currency acceptor into a signal a recognizable by said digital computer terminal. The present invention also relates to a system for making cash purchases over the Internet comprising:
(a) a digital computer terminal;
(b) a pliant currency acceptor having an information output to said digital computer terminal, indicating the value of the currency accepted therein;
(c) a software package comprising a means to purchase merchandise or services over the Internet using the value of currency deposited into said pliant currency acceptor by the user and indicating to an Internet vendor the value of currency deposited by the user into said pliant currency acceptor.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A method for purchasing items on the Internet comprising:
(a) accessing a public online computer terminal said computer terminal comprising:
(i) a digital computer having at least a memory, a CPU, a display, and input components;
(ii) a pliant currency acceptor having output to said digital computer indicative of the amount of currency inserted therein;
(iii) a serial interface circuit connected between said digital computer and said pliant currency acceptor;
(iv) a public telecommunications interface connected to said digital computer and connected to a public telecommunications channel;
(v) a software system on a computer readable medium, the system for the purchase of merchandise or services through the use of said terminal, wherein said software system includes a telecommunications software for purchasing merchandise and services through a global telecommunications network interface and a public telecommunications channel through the use of payments deposited into said pliant currency acceptor, wherein said pliant currency acceptor is used with said software system for determining the quantitative monetary value of currency inserted therein;
(b) selecting an Internet purchase on said online computer terminal;
(c) depositing currency into said pliant currency acceptor;
(d) completing the purchase after a required amount of currency has been inserted into said pliant currency acceptor by transmitting to an Internet vendor a desired manner in which the purchaser will receive the goods or services purchased.

2. The method of claim 1 further comprising a circuit linking said pliant currency acceptor and said digital computer terminal that includes an optically isolated control operated by said digital computer.

3. The method of claim 1 wherein said software package records the value of currency inserted into said pliant currency acceptor and communicates the value inserted to an Internet vendor.

4. The method of claim 1 wherein in said software includes a program for displaying on said digital computer display the services available on said global network; monitors the user selections of desired services; and executes a subroutine program to provide the user the services selected.

5. The method of claim 1 wherein in said software includes a program for displaying on said digital computer display the merchandise available on said global network; monitors the user selections of desired services; and executes a subroutine program to provide the user the merchandise selected.

6. The method of claim 1 wherein said software further includes a monitoring of said pliant currency acceptor to determine the value of currency inserted and the additional value required to complete a purchase.

7. The method of claim 1 wherein said serial interface circuits converts the output signal from the pliant currency acceptor into a signal a recognizable by said digital computer terminal.

8. A system for making cash purchases over the Internet comprising:
a. a digital computer terminal;
b. a pliant currency acceptor having an information output to said digital computer terminal, indicating the value of the currency accepted therein;
c. a software system on a computer readable medium, the system being for the purchase of merchandise or services through the use of said terminal, wherein said software system includes a telecommunications software for purchasing merchandise and services through a global telecommunications network interface and a public telecommunications channel and further wherein said purchase comprises the purchase of merchandise and/or services through the use of payments deposited into said pliant currency acceptor, wherein said pliant currency acceptor is used with said software system for determining the value of currency inserted therein.
